(19) United States
(12) Patent Application Publication
(10) Pub. No.: US 2007/0143315 A1
(43) Pub. Date: Jun. 21, 2007

(54) Inter-partition communication in a virtualization environment

(76) Inventor: Alan Stone, Morristown, NJ (US)

Correspondence Address: FISH & RICHARDSON, PC, P.O. BOX 1022, MINNEAPOLIS, MN, 55440-1022, US

(21) Appl. No.: 11/315,579

(22) Filed: Dec. 21, 2005

(51) Int. Cl. G06F 7/00

(52) U.S. Cl. 707/100

(57) ABSTRACT

Techniques for enabling applications of software stacks in different virtualization partitions to communicate using data elements, each data element including a metadata descriptor having one or more property-value pairs, the enabling including identifying a relationship between a first application and a second application based on a data element provided by each of the first application and the second application.

### CROSS-REFERENCE TO RELATED APPLICATIONS

This application is also related to U.S. application Ser. No. ______ filed Dec. 21, 2005, entitled “Inter-Node Communication in a Distributed System,” being filed concurrently with the present application, which is also incorporated herein by reference.

### BACKGROUND

This description relates to inter-partition communication in a virtualization environment.

In a typical non-virtualized computing system, a single operating system controls underlying hardware resources. A virtualization environment for a computing system generally includes a software component (“virtual machine monitor”) that arbitrates accesses to the hardware resources so that multiple software stacks, each including an operating system and applications, can share the resources. The virtual machine monitor presents to each software stack a set of virtual platform interfaces that constitute a virtual machine. In so doing, the virtual machine monitor virtualizes the computing system into multiple virtual partitions. Virtualizing a computing system can improve overall system security and reliability by isolating the multiple software stacks in the virtual machines. Security may be improved because intrusions can be confined to the virtual machine in which they occur, while reliability can be enhanced because software failures in one virtual machine do not affect the other virtual machines. Current virtual machine monitors enable software stacks in different virtual partitions to communicate with one another using techniques typically based on shared memory or networking.

### DESCRIPTION OF DRAWINGS

FIG. 1 is a block diagram of a virtualization environment.

FIG. 2 is a flow chart of a data content sharing process.

FIG. 3 is a flow chart of a data content retrieval process.

### DETAILED DESCRIPTION

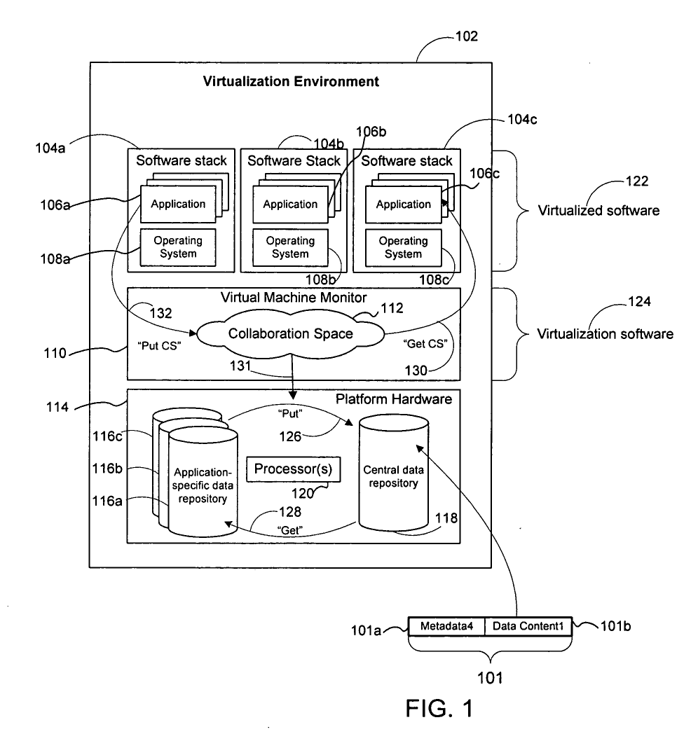

Referring to FIG. 1, a computing system 100 includes virtualized software 122, virtualization software 124, and platform hardware 114. The virtualization software 124 includes a software component, referred to in this description as a virtual machine monitor 110, that virtualizes the platform hardware 114 of the system 100 to provide a virtualization environment 102 in which multiple virtualization partitions co-exist. Each virtualization partition has a software stack 104 that includes applications 106 and an operating system 108. Provision of a multi-partitioned virtualization environment 102 enables multiple instances of one or more different operating systems to run on a single computing system 100.

The virtual machine monitor 110 manages all hardware resources (e.g., processors 120, memory, and I/O devices) in a way that allows each partition's software stack 104 to have the illusion that it fully “owns” the underlying hardware and is thus the only system running on it. That is, the virtual machine monitor 110 presents a virtual machine to each software stack 104 and arbitrates access to the hardware resources in the underlying platform hardware 114 such that an operating system 108a or application 106a of one software stack 104a is unaware of the resource sharing that is taking place with an operating system 108b or application 106b of another software stack 104b.

Each application 106 of a software stack 104 in a virtualization partition has its own address space (“application-specific data repository”) 116 in which the application 106 can store data content and metadata descriptors. In some implementations, each metadata descriptor has one or more property-value pairs structured in accordance with a well-formed platform agnostic schema, such as the XML (eXtensible Markup Language) schema. Although the examples below refer to a data content having an associated metadata descriptor that describes attributes of the data content, there are instances in which a metadata descriptor stored in an application-specific data repository 116 is not associated with a data content, and also instances in which a data content is not associated with a metadata descriptor.

The virtual machine monitor 110 can be implemented to provide a service, referred to in this description as a collaboration space 112, that enables applications of software stacks 104 in different virtualization partitions to communicate (e.g., share/retrieve data content, metadata descriptor, or both) without involving the operating systems 108 of the other respective software stacks 104. The collaboration space 112 is logically defined to support at least the following properties and primitives: (1) memory operations are performed using associative addressing, that is, addressing without physical or virtual addressing; (2) an application that is a data content source need not know anything about an application that is a data content sink and vice versa; and (3) an application that is a data content source need not be running (e.g., spawned or active) at the same time as an application that is a data content sink and vice versa. The collaboration space 112 can be implemented as a library of procedures for managing an address space (“central data repository”) of the virtual machine monitor 110. The library includes routines that enable an application of a software stack 104 of a virtualization partition to perform simple memory operations, such as a PUT procedure for storing data content 101b in the central data repository 118 and a GET procedure for retrieving data content 101b from the central data repository 118. In some implementations, the library of procedures derives a set of instruction classes from the native instructions of a processor's instruction set architecture. In some implementations, the processor's instructions set architecture is extended to include collaboration space specific instructions, such as a PUT_CS instruction and a GET_CS instruction, that support the properties and primitives of the collaboration space 112.

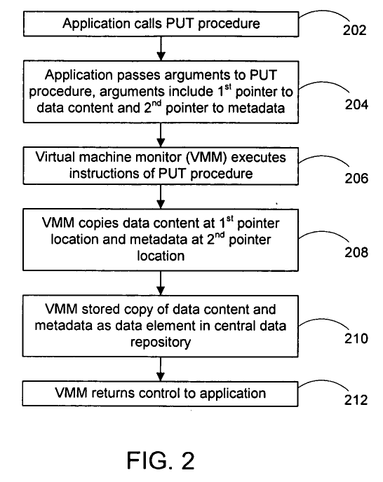

FIG. 2 shows a flow chart of a data content sharing process 200. To share a data content 101 located in its application-specific data repository 116, an application 106a calls (202) the PUT procedure and passes (204) arguments to the PUT procedure to effect a store request. In one implementation, the application 106a passes two pointers as arguments. The first pointer is to a location in the application-specific data repository 116a in which the data content (101b) to be shared is stored. The second pointer is to a location in the application-specific data repository 116a in which the metadata descriptor (101a) associated with the data content to be shared is stored.

The virtual machine monitor 110 executes (206) the instruction(s) of the PUT procedure, copies (208) the data content and metadata descriptor from the locations in the application-specific data repository 116a indicated by the pointers, and stores (210) the copies of the data content and metadata descriptor in the central data repository 118. In some implementations, the copies of the metadata descriptor 101a and data content 101b are stored in the central data repository 118, as a tag and payload respectively, of the data element 101 at a location of the central data repository 118 that is indirectly addressable by the metadata descriptor 101a. Once the data element 101 is stored, control is returned (212) to the application 106a in the usual way procedure calls return.

As previously-discussed, a metadata descriptor describes attributes of its associated data content. In some examples, a data element stored in the central data repository 118 has a metadata descriptor that provides a name for its associated data content. The name can be a globally unique identifier (e.g., C84D7-211E8-G0CD5-E73AC) or an identifier representative of a function of data content (e.g., name=“RESET”, speed=“125 Mb/s”, security=“ON”).

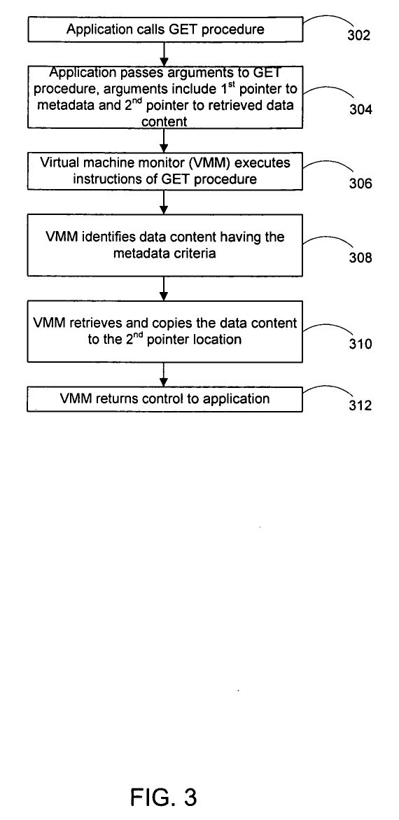

FIG. 3 shows a flow chart of a data content retrieval process 300. To retrieve a data content 101b located in the central data repository 118, an application 106c calls (302) the GET procedure and passes (304) arguments to the GET procedure to effect a retrieval request. In one implementation, the application 106c passes two pointers as arguments. The first pointer is to a location in the application-specific data repository 116c in which a metadata descriptor is stored. The second pointer is to a location in the application-specific data repository 116c in which the retrieved data content is to be stored. The metadata descriptor at the location of the application-specific data repository 116c indicated by the first pointer defines attributes of data content that the application 106c desires to retrieve. In an example scenario, the metadata descriptor at the first location includes a name (name=*), where the (*) represents a wildcard property value.

The virtual machine monitor 110 executes (306) the instruction(s) of the GET procedure, identifies (308) each data element having a metadata descriptor that satisfies that name=* metadata criteria, and copies (310) the data content of each identified data element in the central data repository (118) to the second location pointed to in the application-specific data repository 116c. Provision of a wild card property value (*) and predicated logic (e.g. AND, OR) in the metadata descriptor of name=* enables data content to be selected based on criteria matching. For example, metadata descriptor of name=“RESET”, name=“LOAD”, and name=“SHUTDOWN” or name=“RESET” OR “LOAD” will allow or constrain the data to be retrieved by the GET procedure call. Once the data content of the data element is stored in the application-specific data repository 116c, control is returned (312) to the application 106c in the usual way procedure calls return.

Any number of data content sharing processes and data content retrieval processes can occur simultaneously without interfering or involving other on-going processes. The collaboration space service (112) in the virtual machine monitor mediates all PUT and GET transactions and ensures they are atomic. Thus, partitions execute asynchronously.

Inclusion of a collaboration space 112 in a virtualization environment 102, as described above in relation to FIGS. 1 to 3, enables applications in software stacks of different virtualization partitions to interact and communicate to the exclusion of the operating systems of the respective partitions. The use of a collaboration space 112 by applications also enables faster paths to memory and the processor(s) of the underlying platform hardware 114. If a failure occurs on a processor or in an application, the collaboration space 112 is not compromised as the collaboration space 112 may have a memory space separate from that of the processor itself in some implementations. Separate memory allows for quick restart, checkpointing (a technique for recovery of data for fault tolerant applications), and replication. Overall, the complexity of the system 100 is reduced and processing performance, reliability, and efficiency increases as a result of moving these intercommunication and memory transfer operations from application space to the VMM (virtual machine monitor) space possibly assisted by hardware implementation.

In addition to the inter-partition communications described above, the collaboration space 112 may provide additional services specific to the collaboration space (“CS services”) such as encryption policies, replication policies, persistence policies, eviction policies, access control privileges, or other functions. Applications optionally parameterize or enable and disable such CS services by including relevant reserved system directives in the metadata descriptors of data elements passed to the collaboration space. Suppose, for example, that the data elements placed in the collaboration space 112 are to be encrypted for security reasons. An optional reserved property such as “encrypt” may be enabled by denoting “TRUE” value (i.e., encrypt=TRUE). The collaboration space adaptor interprets the property-value pairs associated with the service directives and takes appropriate action (in this example, encrypting both the metadata descriptor and the payload of a data element). In this way, the collaboration space is extensible to include such optional features in different implementations. Further, CS services are directly controlled by applications without the need to invoke special interfaces. All such communication is simply performed by placing data elements into the collaboration space 112.

In some implementations, the collaboration space 112 may span more than one virtualization environment allowing it to present the same services across a network with other virtualization environments (i.e. platforms). In such implementations, the same capabilities are extended to multiple platforms in the network with the benefit of the collaboration space again not requiring any physical or virtual address of the nodes to be known by the application software.

The techniques of one embodiment of the invention can be performed by one or more programmable processors executing a computer program to perform functions of the embodiment by operating on input data and generating output. The techniques can also be performed by, and apparatus of one embodiment of the invention can be implemented as, special purpose logic circuitry, e.g., one or more FPGAs (field programmable gate arrays) and/or one or more ASICs (application-specific integrated circuits).

Processors suitable for the execution of a computer program include, by way of example, both general and special purpose microprocessors, and any one or more processors of any kind of digital computer. Generally, a processor will receive instructions and data from a memory (e.g., memory 330). The memory may include a wide variety of memory media including but not limited to volatile memory, non-volatile memory, flash, programmable variables or states, random access memory (RAM), read-only memory (ROM), flash, or other static or dynamic storage media. In one example, machine-readable instructions or content can be provided to the memory from a form of machine-accessible medium. A machine-accessible medium may represent any mechanism that provides (i.e., stores or transmits) information in a form readable by a machine (e.g., an ASIC, special function controller or processor, FPGA or other hardware device). For example, a machine-accessible medium may include: ROM; RAM; magnetic disk storage media; optical storage media; flash memory devices; electrical, optical, acoustical or other form of propagated signals (e.g., carrier waves, infrared signals, digital signals); and the like. The processor and the memory can be supplemented by, or incorporated in special purpose logic circuitry.

Other embodiments are within the scope of the following claims. For example, the techniques described herein can be performed in a different order and still achieve desirable results. Another example of a system that

What is claimed is:

1. A method comprising:
enabling applications of software stacks in different virtualization partitions to communicate using data elements, each data element including a metadata descriptor having one or more property-value pairs, the enabling comprising identifying a relationship between a first application and a second application based on a data element provided by each of the first application and the second application.

2. The method of claim 1, wherein the at least one property-value pair is structured in accordance with a schema.

3. The method of claim 2, wherein the schema comprises a XML schema.

4. The method of claim 1, wherein the enabling comprises:
performing a communication comprising a memory operation.

5. The method of claim 4, wherein the memory operation is performed without involving an operating system of at least one of the software stacks.

6. The method of claim 1, wherein the enabling comprises:
storing one of the data elements at a location in a central data repository that is indirectly addressable using the metadata descriptor.

7. The method of claim 6, wherein the storing is performed without involving an operating system of an application of any of the software stacks.

8. The method of claim 1, wherein the enabling comprises:
receiving, from an application of one of the software stacks, a request to store the data element in the central data repository.

9. The method of claim 8, wherein the request comprises a first pointer to a data content stored at a first location in an application-specific data repository.

10. The method of claim 9, wherein the request further comprises a second pointer to a metadata descriptor stored at a second location in the application-specific data repository, the metadata descriptor defining at least one attribute of the data content stored at the first location.

11. The method of claim 1, wherein the enabling comprises:
retrieving a data element from a location in a central data repository that is addressable using a metadata descriptor.

12. The method of claim 1, wherein the enabling comprises:
receiving, from an application of one of the software stacks, a request to retrieve data elements associated with a first metadata descriptor.

13. The method of claim 12, wherein the request comprises a first pointer to the first metadata descriptor stored at a first location in an application-specific data repository.

14. The method of claim 13, wherein the request further comprises a second pointer to a second location in the application-specific data repository, the second location for storing the retrieved data elements having the first metadata descriptor.

15. The method of claim 12, further comprising:
identifying data elements, stored in respective locations in the central data repository, having the first metadata descriptor; and
retrieving the identified data elements from respective locations in the central data repository.

16. A machine-accessible medium comprising content, which, when executed by a machine causes the machine to:
enable applications of software stacks in different virtualization partitions to communicate using data elements, each data element including a metadata descriptor having one or more property-value pairs, wherein the content, which, when executed by the machine causes the machine to identify a relationship between a first application and a second application based on a data element provided by each of the first application and the second application.

17. The machine-accessible medium of claim 16, further comprising content, which, when executed by the machine causes the machine to:
perform a memory operation without involving an operating system of at least one of the software stacks.

18. A method comprising:
enabling applications of software stacks of a virtualization environment to communicate without involving at least one operating system of one of the software stacks.

19. The method of claim 18, wherein the enabling comprises enabling the applications to communicate using data elements, each data element including a metadata descriptor having one or more property-value pairs.

20. An apparatus comprising:
a central data repository in which data elements each including a metadata descriptor are stored, the data elements to facilitate communication between applications of software stacks of a virtualization environment.

21. The apparatus of claim 20, wherein the central data repository is managed by a virtual machine monitor of the virtualization environment.

22. A method comprising:
enabling an application of a software stack in a virtualization environment to control one or more parameters of a collaboration space by passing a data element to the collaboration space, the data element comprising a metadata descriptor defining at least one service directive of the collaboration space.

23. The method of claim 22, wherein the at least one service directive comprises a property-value pair.

24. The method of claim 22, wherein the at least one service directive is associated with one or more of the following: an encryption policy, a replication policy, a persistence policy, an eviction policy, and an access control privilege policy.

25. A system comprising:
platform hardware; and
virtualization software that virtualizes the platform hardware to form multiple virtualization partitions of a virtualization environment, each virtualization partition having a software stack comprising an operating system and an application, the virtualization software enabling applications of software stacks in different virtualization partitions to communicate using data elements, each data element including a metadata descriptor having one or more property-value pairs, the enabling comprising identifying a relationship between a first application and a second application based on a data element provided by each of the first application and the second application.

26. The system of claim 25, wherein the virtualization software enables applications of software stacks in different virtualization partitions to communicate without involving an operating system of at least one of the software stacks.

27. The system of claim 25, wherein the virtualization software stores one of the data elements at a location in a central data repository that is indirectly addressable using the metadata descriptor.

28. The system of claim 25, wherein the virtualization software retrieves a data element from a location in a central data repository that is addressable using a metadata descriptor.

29. The system of claim 25, wherein the collaboration space is logically extended to span multiple virtualization environments that are connected using a network.
